(19) United States
(12) Patent Application Publication
(10) Pub. No.: US 2016/0198727 A1
(43) Pub. Date: Jul. 14, 2016

(54) ABSORBENT FOOD PAD WITH SLOW, CONTROLLED RELEASE OF A DESIRED GAS

(71) Applicant: Paper-Pak Industries, Laverne, CA (US)

(72) Inventors: Ronald Jensen, Chicago, IL (US); Sayandro Versteylen, Fontana, CA (US); Brett N. Stoll, Rancho Cucamonga, CA (US)

(21) Appl. No.: 14/592,359

(22) Filed: Jan. 8, 2015

(51) Int. Cl. A23B 4/16

(52) U.S. Cl. CPC A23B 4/16

(57) ABSTRACT

An absorbent food pad in which the rate of release of carbon dioxide is controlled through either or both the chemistry and architecture of the absorbent food pad. In a preferred embodiment, the absorbent food pad has two carbon dioxide generation systems.

### BACKGROUND OF THE DISCLOSURE

1. Field of the Disclosure

The present disclosure provides an absorbent food pad that controls the rate of gas diffusion out of the absorbent food pad. More specifically, the present disclosure provides for a controlled release of carbon dioxide gas using both structural and chemical means.

2. Description of Related Art

Approaches to food preservation are generally designed to enhance the shelf life of packaged products. Before packaging, most foods contain appreciable levels of moisture and fluids that contain bacteria. These fluids and moisture provide nutrients to create a hospitable environment for further bacterial proliferation, which ultimately results in spoilage indicators such as food discoloration, slime, and/or unpleasant odors.

One approach to controlling bacterial growth has been to include a carbon dioxide generation system, which may include a combination of an acid and a base, within the absorbent food pad. Elevating the levels of carbon dioxide in a food package will delay spoilage of the food product placed in the food package. However, this technique still leaves a need for a versatile system of food preservation because of the difficulty associated with maintaining the created atmosphere. Of particular concern when using elevated levels of CO₂, is that CO₂ levels diminish as fluids in the food product absorb the gas.

Conventional food pads place an acid and a base together in a same layer, and thus, when the liquid purge is absorbed by the food pad, a quick reaction ensues. A recent application by the owners of the present application address separating the components with the acid component near the bottom layer and the base component at a distance from the bottom layer. However, it has now been found that the present disclosure further improves the prolongation of the preferred atmosphere.

### SUMMARY OF THE DISCLOSURE

The present disclosure provides an absorbent food pad that controls, via controlled release, the rate of gas diffusion out of the absorbent food pad.

The present disclosure also provides a slow, controlled release of carbon dioxide gas using an absorbent pad construction, namely structural means or chemical means, or a combination of both, in the absorbent food pad.

The present disclosure further provides an absorbent food pad that places an acidic component at a distance from the bottom layer and, preferably, adjacent the top layer of the absorbent pad, and a lower solubility component, such as a base, near the bottom layer.

The present disclosure yet further provides, in one embodiment, a pad architecture in which an acid component is positioned near the top layer of the pad, and a lower solubility component, such as a base, is positioned near the bottom layer and, thus, near the entry point of moisture from the food purge.

The present disclosure also provides, in a second embodiment, a slow, controlled release of carbon dioxide that uses two carbon dioxide generation systems.

The present disclosure further provides such a second embodiment in which a first generation system has an acid component positioned near the top layer of the pad, and a lower solubility component positioned towards the bottom layer of the pad and a second generation system that has an acid component and a lower solubility component positioned together adjacent the bottom layer.

The present disclosure provides a third embodiment, that is separate from or an addition to the first and second embodiments, in which a first generation system has two acid components positioned near the top layer of the pad, and two lower solubility components positioned towards the bottom layer of the pad with each acid and/or each lower solubility component having different properties to further effect the slow, controlled release of CO₂.

### BRIEF DESCRIPTION OF THE DRAWINGS

FIG. 1 is a diagram of the structure of a first embodiment of an absorbent food pad of the present disclosure.

FIG. 2 is a diagram of the structure of a second embodiment of an absorbent food pad of the present disclosure.

FIG. 3 shows a formed absorbent food pad of the present disclosure.

FIGS. 4 to 6 are diagrams of the absorbent food pad in FIG. 2 showing phases of the continuous diffusion pattern of moisture from the food product into the absorbent food pad.

FIG. 7 is a graph showing the correlation between specific pad structures and carbon dioxide release.

### DETAILED DESCRIPTION OF THE DISCLOSURE

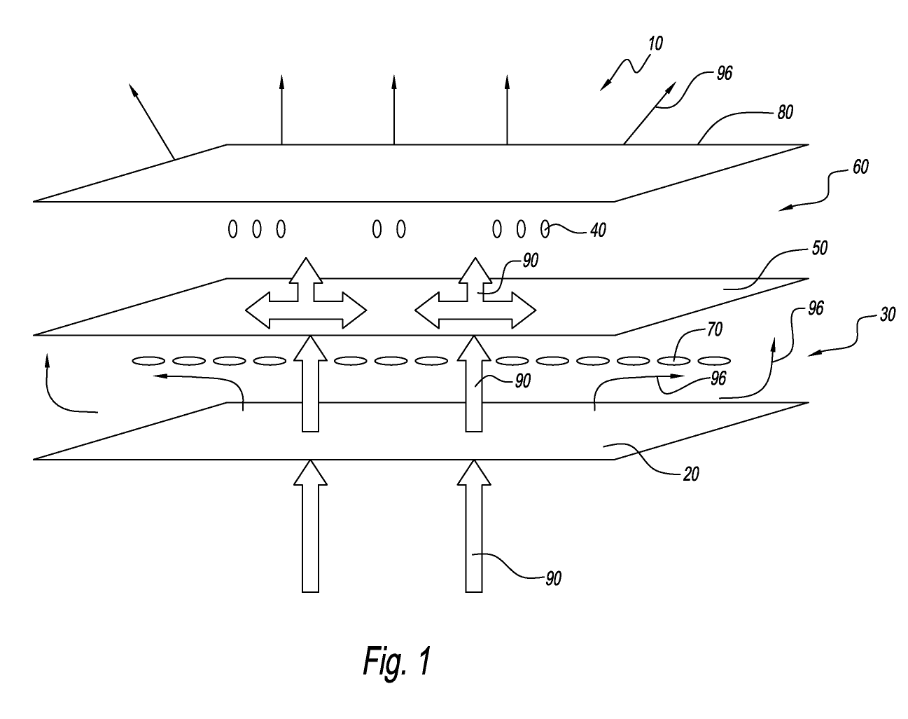

Referring to the drawings and, in particular, FIG. 1, there is shown a first embodiment of an absorbent food pad of the present disclosure generally represented by reference numeral 10. The absorbent food pad 10 has a bottom layer 20, a top layer 80, an intermediate layer 50, a first area or pocket 60 between intermediate layer 50 and top layer 80, and a second area or pocket 30 between bottom layer 20 and intermediate layer 50. A pocket as defined herein means an area between two layers that can hold in place an agent or component of an agent prior to use of the absorbent food pad. A pocket can be made of a single layer or can be a plurality of components.

In first area 60, there is positioned an acid 40. In second area 30, there is positioned a lower solubility component 70. Lower solubility component means a component having a solubility lower than the acid component and, preferably, the lower solubility component is a base. Liquid purge 90, from the food product placed on bottom layer 20, flows into and through bottom layer 20 and into second area 30 having lower solubility component 70. The liquid purge 90 is absorbed in part in the lower solubility component 70 so that the purge and the absorbed portion of the lower solubility component move upward into intermediate layer 50 to contact acid 40 in first area 60.

This first embodiment of the present disclosure addresses weaknesses of the prior art absorbent food pad to achieve a slow, long-acting release of carbon dioxide or CO₂.

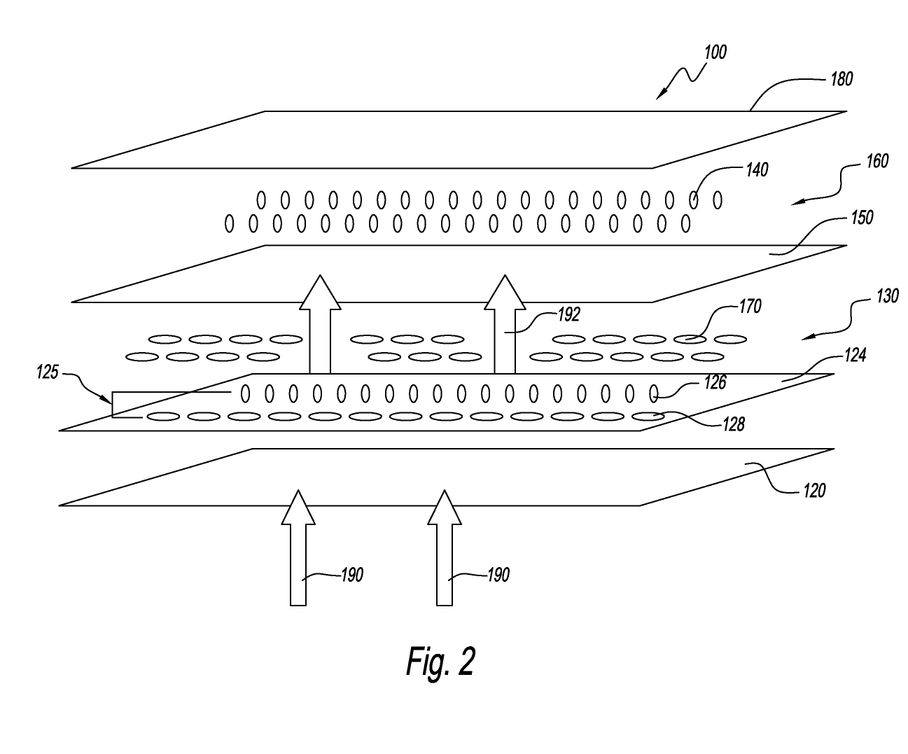

Referring to FIG. 2, there is shown a second exemplary embodiment of an absorbent food pad of the present disclosure generally represented by reference number 100. Absorbent food pad 100, as food pad 10, can be placed underneath a food product to absorb liquid purge 190 exuded from the food product. The particular architecture and chemical makeup of absorbent food pad 100, described in detail below, controls the release, in order to prolong the release, of carbon dioxide 196 from absorbent food pad 100.

Absorbent food pad 100 has the following layers or structure from top to bottom. Absorbent pad 100 has a top layer 180, a first area or pocket 160, a membrane 150, a second area or pocket 130, a first generation layer or pocket 124 and a bottom layer 120. Top layer 180 and bottom layer 120 are the outer layers of absorbent food pad 100. Membrane 150 can be a layer or a laminate. Preferably, it is a laminate of SAP. First area 160 and second area 130 are preferably pockets.

In a preferred embodiment of this second exemplary embodiment, first area 160 is a pocket formed between top layer 180 and membrane 150 and the edges 110 of absorbent pad 100. This pocket 160 can also be formed by one or more tissue layers positioned between top layer 180 and laminate 150, or by a tissue layer (positioned between top layer 180 and laminate 150) and either top layer 180 or membrane 150. Likewise, in a preferred embodiment, second area 130 is a pocket formed between bottom layer 120 and membrane 150 and the edges 110 of absorbent pad 100. This pocket 130 can also be formed by one or more tissue layers positioned between bottom layer 120 and laminate 150, or by a tissue layer (positioned between bottom layer 120 and laminate 150) and either bottom layer 120 or membrane 150.

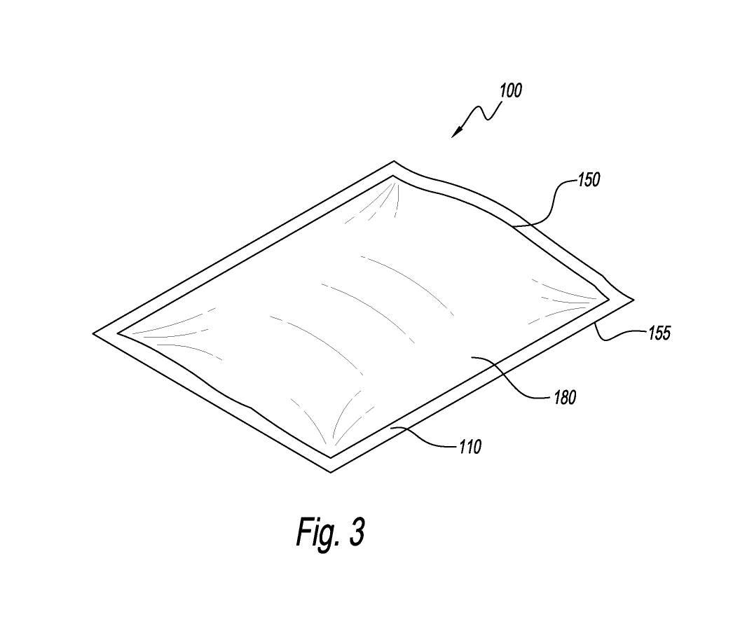

Top layer 180 and bottom layer 120 can be bonded together around a periphery of absorbent food pad 100 as shown in FIG. 3. In one embodiment, the edges of pockets 160 and 130 can be included therebetween to form the edges of the pockets. In another embodiment, top layer 180 and bottom layer 120 can be bonded directly together and, thus, the pockets 160 and 130 are discrete from the edges of the absorbent food pad 100.

Preferably, top layer 180 is a film that can be made of polyethylene, polypropylene, polyester, or any combinations thereof. However, it is possible in some embodiments, although not preferred, that top layer 180 can be micro-perforated or slit. Bottom layer 120 is made of a material pervious to liquids. Preferably, bottom layer 120 can be made of any fabric that permits liquids to flow therein.

Membrane 150 is preferably a SAP laminate. Examples of suitable absorbent materials include, but are not limited to, superabsorbent polymer, compressed SAP composite of superabsorbent polymer granules adhered with one or more binders and/or plasticizers, compressed composite containing a percentage of short or microfiber materials, thermoplastic polymer fibers, thermoplastic polymer granules, cellulose powders, cellulose gels, an airlaid with superabsorbent, any fibrous or foam structure that has been coated or impregnated with a superabsorbent, absorbent structure having one or more starch or cellulose based absorbents, absorbent structure containing superabsorbent material formed and/or cross-linked in-situ, or any combinations thereof. Superabsorbent material can be used in various forms. Examples of suitable superabsorbent material forms include, but are not limited to, granular, fiber, liquid, superabsorbent hot melts, or any combinations thereof. Compressed composites of short and microfiber (from about 0.1 inches to about 0.3 inches in length) materials having between about 3% and about 25% short or micro-fiber content have been shown to strengthen the core for high speed processing but retain the desired properties of low cost and high speed absorption and wicking.

Membrane 150 provides control of the flow of liquid between first area 160 and second area 130. As shown in FIG. 3, membrane 150 can be spaced from a periphery 155 of absorbent food pad 100, in which case the membrane should be absorbent enough to capture liquid that collects between the membrane and periphery 155. Alternatively, membrane 150 can extend out to periphery 155 as discussed above with respect to areas 160 and 130.

Membrane 150 can be one or more layers of material and can be perforated. The exact structure of membrane 150 can be tailored, if desired, based upon on the level of permeability sought to be achieved by membrane 150. For example, whether absorbent food pad 100 is intended to be used to absorb liquid purge from food products that generate a large amount of liquid surge, such as fruits and/or vegetables, or food products that generate a lesser amount of liquid surge, such as pork, the permeability of membrane 150 can be customized to ensure that the appropriate amount of liquid passes therethrough. This pad architecture requires that the liquid purge travel to a top of the food pad to contact the acid, forming an acidic purge that must then travel down through the food pad to contact the lower solubility component.

To maintain or increase the CO₂ levels in a food package, a chemical system can be employed that results in the release of CO₂ through a chemical reaction. One such chemical system that can be used in the present disclosure includes a system with an acid and a lower solubility component, that when reacted together, generate CO₂. As the liquid purge 190 from the food product is absorbed into absorbent food pad 100, the components of the CO₂ generation system dissolve to react with each other and release CO₂ from absorbent food pad 100 as shown by arrows 196.

In the second embodiment shown in FIGS. 2 and 4-6, absorbent food pad 100 includes a first carbon dioxide generation system 125 and a second carbon dioxide generation system. The first carbon dioxide generation system 125 is in first generation area, layer or pocket 124. The first carbon dioxide generation system 125 includes a mixture of a first acid 126 and a first base 128. The first acid 126 is preferably citric acid, which has a solubility in water of 147 g/100 mL at approximately 20 degrees Celsius. The first base 128 is preferably sodium bicarbonate, which has a solubility in water of 96 g/L at approximately 20 degrees Celsius. It should be understood that other acids and/or bases can be used and are listed below. The first acid 126 and first base 128 can be kept separate prior to activation by physical separation in first generation layer 124.

The presence of the first carbon dioxide generation system 125 in first generation layer 124 allows CO₂ to be generated as soon as the liquid purge 190 passes through bottom layer 120 and contacts first generation layer 124 as shown by arrows 196. First carbon dioxide generation system 125 will continuously generate CO₂ for a period of one to two days.

The second carbon dioxide generation system includes a mixture of a second acid 140 and a low solubility component 170. The second acid 140 can be the same acid as the first acid 126. The low solubility component 170 can be a base, and even the same lower solubility component or base as the first lower solubility component 128.

The solubilities of the second acid 140 and the low solubility component 170 can be tailored to achieve a desired CO₂ release depending on the food product that absorbent pad 100 is intended to be used with. The solubility of the second acid 140 in water can range from 0.001 to 5.0 g/mL at approximately 20 degrees Celsius. More specifically, the solubility of the second acid 140 in water at approximately 20 degrees Celsius can fall into one of three ranges: a lower range of 0.001-0.05 g/mL; an intermediate range of 0.05-1.00 g/mL; and an upper range of 1.0-5.0 g/mL. The solubility of low solubility component 170 in water at approximately 20 degrees Celsius can range from 0.00001 to 2.0 g/mL. More specifically, the solubility of the low solubility component 170 in water at approximately 20 degrees Celsius can fall in one of three ranges: a lower range of 0.00001-0.001 g/mL; an intermediate range of 0.001-0.1 g/mL; and an upper range of 0.1-2.0 g/mL, but in no event should the solubility of low solubility component 170 be equal to or exceed the solubility of second acid 140.

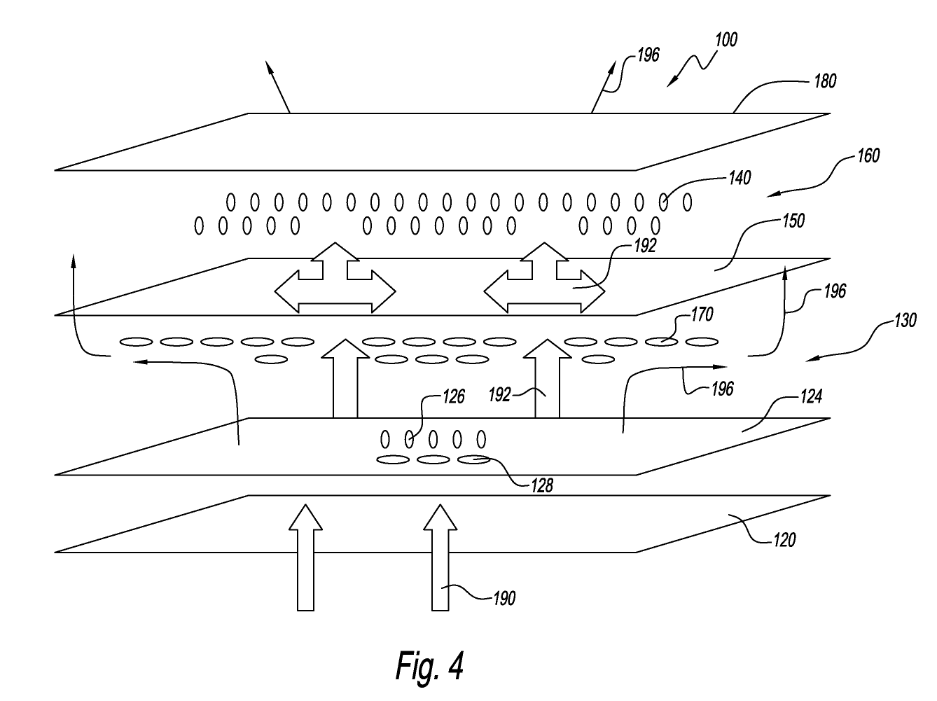

As shown in FIGS. 4-6, the pad structure of the second carbon dioxide generation system physically separates second acid 140 from low solubility component 170 in absorbent food pad 100 prior to activation. This pad structure ensures that the second carbon dioxide generation system will continuously generate CO₂ for a period of several days after the one-to-two-day reaction period of the first carbon dioxide generation system 125.

As discussed above, first area 160 and second area 130 are preferably pockets in the absorbent food pad 100. The second acid 140 is positioned in first pocket 160 and low solubility component 170 is positioned in second pocket 130. This arrangement positions the low solubility component 170 near bottom layer 120, and thus near liquid purge 190 to be absorbed, and positions second acid 140 the furthest away from the entering liquid purge 190.

The architecture of absorbent food pad 100 of the present disclosure, besides the addition of first generation layer 124, reverses the positions of the acid and low solubility components in the absorbent pad 100 as compared to applicant's own prior absorbent food pad 10. In that prior art absorbent food pad, the acid is in a lower pocket near the bottom layer and a base is in an upper pocket near top layer. By reversing the location of acid 140 and also using a low solubility component 170 as shown in FIG. 2, the present disclosure ensures that the low solubility component 170 is the first component contacted and, thus, activated by liquid purge 190 and that less liquid purge, due to passage through the absorbent pad 100, contacts second acid 140.

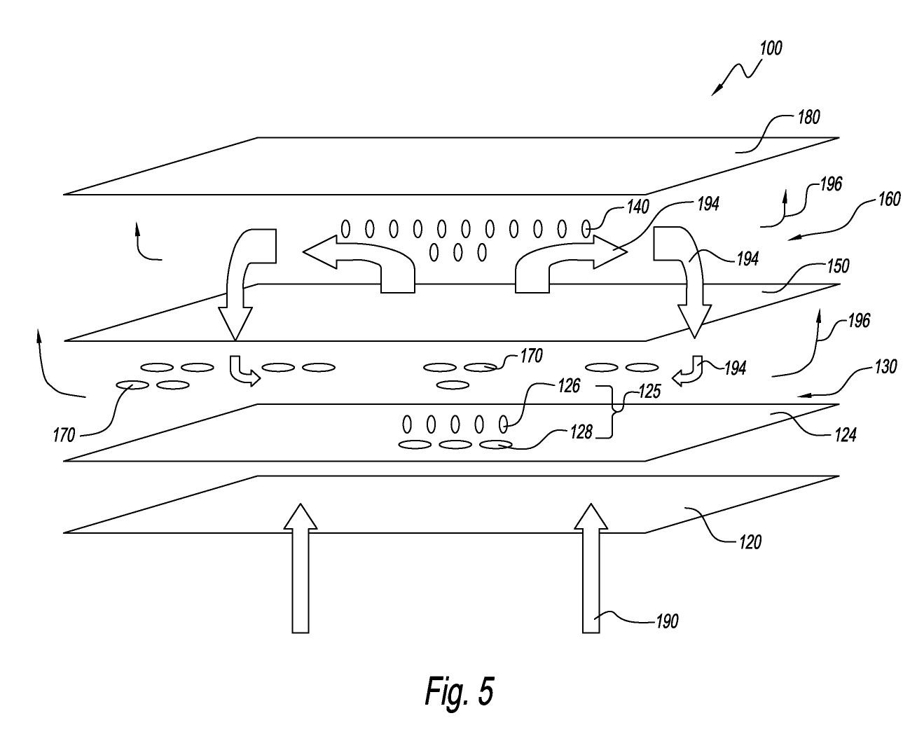

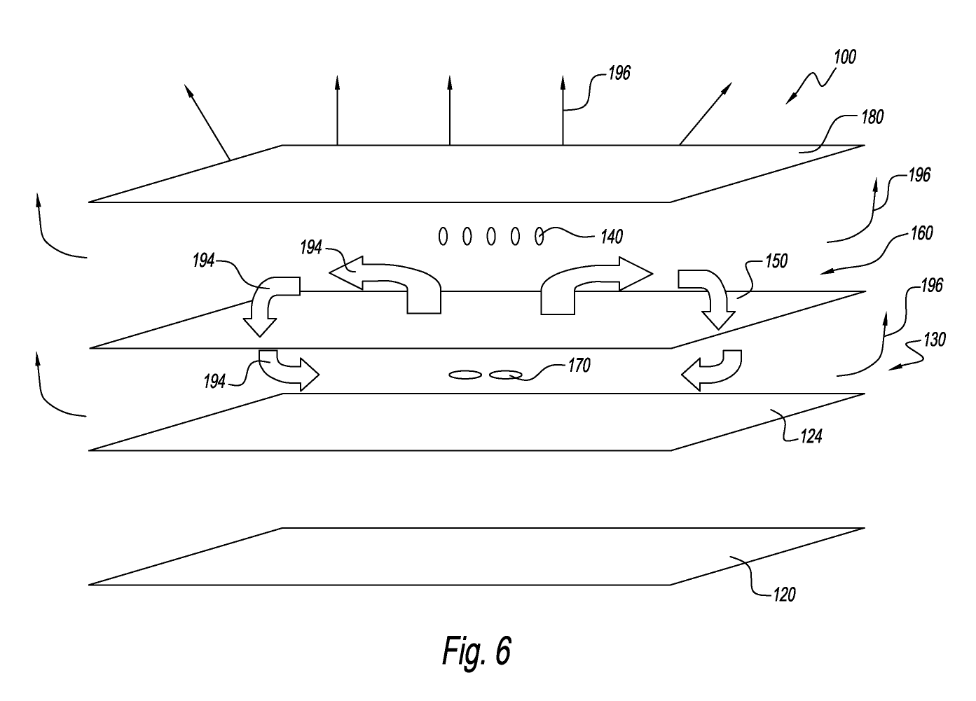

Referring again to FIGS. 2 and 4 to 6, when second acid 140 is citric acid and low solubility component 170 is sodium bicarbonate, the liquid purge 190 diffuses upward through absorbent food pad 100 and passes through low solubility component 170 to form low solubility purge 192. As shown in FIG. 4, low-solubility purge 192 diffuses upward through absorbent food pad 100 and contacts second acid 140 such that low-solubility purge 192 becomes acidic purge 194 as shown in FIG. 5. Acidic purge 194 must travel down to second layer 130 to contact low solubility component 170, thereby generating CO₂, H₂O, and sodium citrate as shown by arrows 196 in FIG. 6. When acids other than citric acid are used for second acid 140, an ionic salt other than sodium citrate will form.

Citric acid dissolves more quickly in liquid than bicarbonate. Thus, the generation of CO₂ is slowed in comparison with a conventional absorbent food pad due to the architecture and the second generation system of the absorbent food pad 100 even without first generation system 125.

The first acid 126 and second acid 140 of the present disclosure can be an organic acid, an inorganic acid, or a combination of both. An example of a preferred inorganic acid is boric acid. Examples of preferred organic acids are citric acid, benzoic acid, sorbic acid, lactic acid, acetylsalicylic acid, fumaric acid, ascorbic acid, estearic acid, a carboxylic acid, and any combinations thereof. The first acid 126 can be the same acid as the second acid 140.

The release of CO₂ can be controlled not only by the pad architecture, described above, but also through chemical means, such as by changing the strength and solubilities of acids and bases being used. This can be done in addition to or instead of using the pad architecture described above. For example, boric acid is a very weak acid and can be used to slow the rate of release of CO₂ as needed. Although removal of the first proton in boric acid occurs quickly, removing the second and third protons in boric acid occurs much more slowly, prolonging the rate of reaction.

The first base 128 and low solubility component 170 of the present disclosure can each be a carbonate, such as sodium carbonate, sodium bicarbonate, magnesium carbonate, potassium carbonate, calcium carbonate, barium carbonate, or any combination thereof. Sodium carbonate can be used as either or both first base 128 and low solubility component 170, instead of sodium bicarbonate, to further slow the reaction kinetics.

Use of magnesium carbonate, calcium carbonate, potassium carbonate, and/or barium carbonate may be preferable over sodium carbonate and sodium bicarbonate to provide an absorbent food pad 100 that contains little to no sodium.

The chemical reaction listed below is one example of a combination of acids and bases that can be used with the absorbent food pad 100 of the present disclosure.

K₂CO₃+CaCO₃+citric acid→CO₂+Ca-citrate+K-citrate

The benefit of such an embodiment is that the calcium salts will provide a better-buffered system that makes the absorbent food pad 100 extremely resistant to changes in pH levels. This is important since it allows the system to maintain a pH that is compatible with the preservation of a particular food product.

In still another embodiment of an absorbent food pad 100 of the present disclosure, first carbon dioxide generation system 125 and second carbon dioxide generation system 140 and 170 include a combination of sodium carbonate (Na₂CO₃) and sodium bicarbonate (NaHCO₃) to provide a two-step process that will further control the release of CO₂. When contacted by an acid, Na₂CO₃ generates NaHCO₃, which then reacts with further hydrogen ions to produce CO₂. This chemical reaction is provided below:

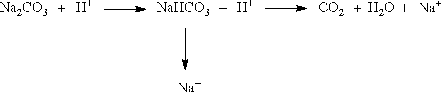

Thus, by this embodiment, it is believed that the composition of the chemicals can achieve a slower release even if there is no change in the architecture of the absorbent food pad 100 from that of the prior art absorbent food pad. By mixing two different bases, such as sodium carbonate and sodium bicarbonate, or two different acids, such as citric acid and boric acid, where each base and/or each acid have (1) different solubilities in water, (2) different dissociation constants and/or (3) a different number of active sites, the release of CO₂ can yet be extended by this mechanism.

In a portion of the absorbent food pad 100 that is most accessible to dissolved liquid, i.e., intermediate layer 150, the sodium bicarbonate is placed to quickly generate high levels of CO₂. In a less-accessible portion of the absorbent food pad 100, i.e., the lower pocket 130, the sodium carbonate can be placed to serve as a reservoir that provides for a delayed and extended release of CO₂ through the chemical reaction listed above.

In yet another embodiment of an absorbent food pad 100, a three-step process is provided to better control the rate of release of CO₂. This involves using calcium carbonate in addition to the combination of sodium carbonate and sodium bicarbonate. If sodium bicarbonate is the only component of first base 128, it is rapidly consumed when it contacts first acid 126. However, by using CaCO₃, HCO₃ is formed during an intermediate step and will neutralize any residual acids in the liquid purge.

The particle size can also be varied to either speed or slow the rate of dissolution. For instance, the particle size of Na₂CO₃ could be smaller to speed dissociation, while the size of NaHCO₃ could be larger to slow dissociation.

Additionally, the concentrations of the first base 22 and the low solubility component 170 can be adjusted to neutralize the acids in the systems. When second acid 140 reacts to form an ionic salt, such as sodium citrate, the ionic salt acts as a buffer and reduces the strength of the second acid 140.

In addition to a reversed pad architecture, allowing modification of the absorbency of the membrane 150 and the particular acids and bases used in first carbon dioxide generation system 125 and second carbon dioxide generation system 140 and 170, enables the absorbent food pad 100 to achieve a controlled release of CO₂ that can be fine-tuned to accommodate the particular food product being used. For example, for products with a relatively long shelf-life, such as chicken, tilapia, fruits, and vegetables, a delayed release of CO₂ is desired and can be achieved through use of the present disclosure. For products with a shorter shelf-life, such as meats, such an extended and delayed release of CO₂ is not necessary, and thus the structural and chemical means of absorbent food pad 100 can be adjusted accordingly. Therefore, absorbent food pad 100 advantageously allows the release of carbon dioxide to be controlled as needed depending on the food product being used.

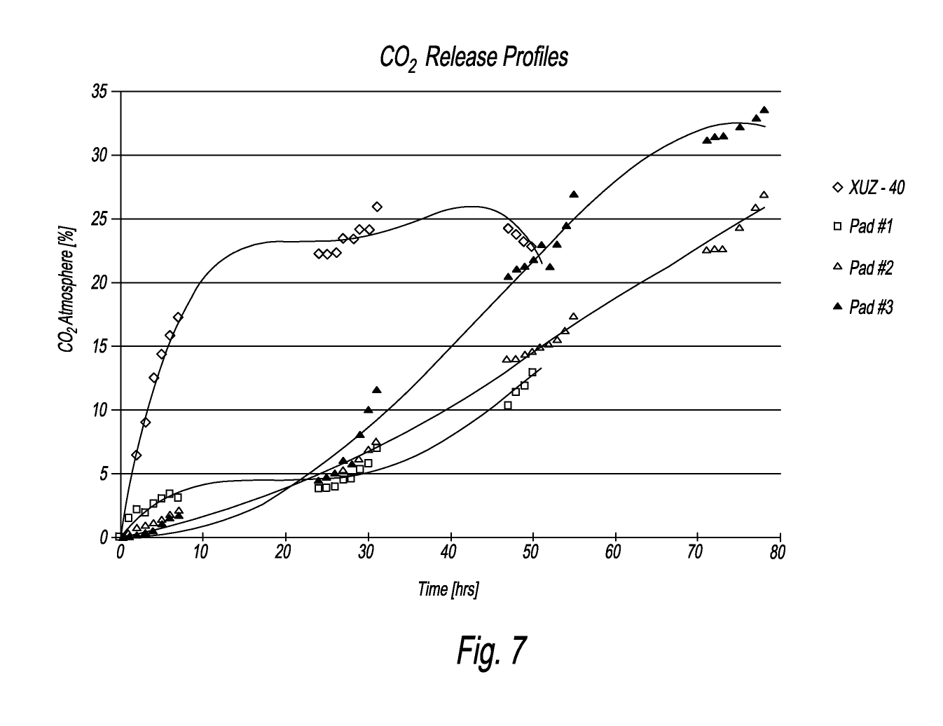

Referring to FIG. 7, XUZ-40 refers to a pad having the following structure from bottom to top: a nonwoven polypropylene; three tissue layers; a laminate having a mixture of an acid and a base together therein; three tissue layers; and a polypropylene film.

Pad #1 is an absorbent pad 100 but with the following structure from bottom to top: a nonwoven polypropylene; a tissue layer; a laminate having a mixture of an acid and a low solubility component together therein; a tissue layer; a membrane that is a SAP laminate having an absorbency of 4.5 grams per square inch (GSI); a tissue layer; 1.122 g of bicarbonate placed in a first pocket; a membrane that is a SAP laminate having an absorbency of 4.5 GSI; 0.748 g citric acid placed in a second pocket; a tissue layer; and a polypropylene film.

Pad #2 is an absorbent pad 100 but with the following structure from bottom to top: a nonwoven polypropylene; a tissue layer; 1.122 g of bicarbonate added to a membrane of SAP having an absorbency of 2.5 GSI; two tissue layers; 0.748 g of citric acid added to a membrane of SAP having an absorbency of 4.5 GSI; two tissue layers; a membrane that is a SAP laminate having an absorbency of 4.5 GSI; a laminate having a mixture of an acid and a low solubility component together therein; and a polypropylene film.

Pad #3 is an absorbent pad 100 but with the following structure from bottom to top: a nonwoven polypropylene; a membrane that is a SAP having an absorbency of 2.0 GSI; 1.122 g of bicarbonate added to a membrane that is a SAP having an absorbency of 2.0 GSI; 1.496 g of citric acid added to a membrane that is a SAP having an absorbency of 2.0 GSI; 1.122 g bicarbonate added to a membrane that is a SAP having an absorbency of 2.0 GSI; a membrane that is a SAP laminate having an absorbency of 2.0 GSI; and a polypropylene film.

As shown in FIG. 7, the timing and quantity of CO₂ release shown as arrows 196 in FIGS. 4-6, can be controlled by changing the structure and/or chemical composition of components used in absorbent food pad 100. Pad #1 significantly slows the release of CO₂ compared to the XUZ-40 pad. Pad #2 controls by slowing the release of CO₂ so that the release of CO₂ continues for over 70 hours before it declines. Pad #3 controls by slowing the release of CO₂ so that the release of CO₂ continues for over 70 hours before it begins to slowly decline. Thus, each of pads #1, #2, and #3 provides for continuous CO₂ generation over a period of several days due to each having an acid spaced from the liquid purge and having a lower solubility component placed near the liquid purge.

As used in this application, the word “about” for dimensions, weights, and other measures means a range that is ±10% of the stated value, more preferably ±5% of the stated value, and most preferably ±1% of the stated value, including all subranges therebetween.

It should be understood that the foregoing description is only illustrative of the present disclosure. Various alternatives and modifications can be devised by those skilled in the art without departing from the present disclosure. Accordingly, the present disclosure is intended to embrace all such alternatives, modifications, and variances that fall within the scope of the disclosure.

What is claimed is:

1. An absorbent food pad for controlled release of CO₂ comprising:
a top layer;
a bottom layer that is liquid permeable;
a membrane positioned between the top layer and the bottom layer, wherein the top layer and the membrane form an upper pocket, and wherein the bottom layer and the membrane form a lower pocket; and
a carbon generation system that includes an acid and a low solubility component,
wherein the acid is positioned in the upper pocket and the low solubility component is positioned in the lower pocket to slow the release of CO₂.

2. The absorbent food pad of claim 1, wherein the acid is selected from the group consisting of a carboxylic acid, citric acid, boric acid, sorbic acid, lactic acid, acetylsalicylic acid, fumaric acid, ascorbic acid, estearic acid and any combinations thereof.

3. The absorbent food pad of claim 1, wherein the acid has a solubility in water within a range of 0.001 to 5.0 g/100 mL at approximately 20 degrees Celsius.

4. The absorbent food pad of claim 1, wherein the low solubility component is selected from the group consisting of potassium carbonate, magnesium carbonate, calcium carbonate, barium carbonate, and any combinations thereof.

5. The absorbent food pad of claim 4, wherein the low solubility component has a solubility in water within a range of 0.00001 to 2.0 g/100 mL at approximately 20 degrees Celsius.

6. The absorbent food pad of claim 1, wherein the solubility of the low solubility component in water is less than the solubility of the acid in water.

7. An absorbent food pad for controlled release of CO₂ comprising:
a top layer;
a membrane;
a first pocket positioned between the top layer and the membrane;
a second pocket positioned adjacent the membrane opposite the first pocket;
a bottom layer that is liquid permeable;
an intermediate layer positioned between the second pocket and the bottom layer;
a first carbon generation system that includes a first acid and a first lower solubility component in the intermediate layer; and
a second carbon generation system that includes a second acid positioned in the upper pocket and a second lower solubility component positioned in the lower pocket,
wherein the absorbent food pad has a slow release of CO₂.

8. The absorbent food pad of claim 7, wherein the first acid is the same acid as the second acid.

9. The absorbent food pad of claim 7, wherein the first acid and/or the second acid is citric acid.

9. The absorbent food pad of claim 7, wherein the first lower solubility component is the same component as the second lower solubility component.

10. The absorbent food pad of claim 9, wherein the first and second lower solubility components are bases.

11. The absorbent food pad of claim 7, wherein the first and/or the second lower solubility component is sodium bicarbonate.

12. The absorbent food pad of claim 7, wherein the first and/or the second acid is selected from the group consisting of citric acid, boric acid, sorbic acid, lactic acid, acetylsalicylic acid, fumaric acid, ascorbic acid, estearic acid, and any combinations thereof.

13. The absorbent food pad of claim 7, wherein the first and/or the second lower solubility component is selected from the group consisting of potassium carbonate, magnesium carbonate, calcium carbonate, barium carbonate, and any combinations thereof.

14. The absorbent food pad of claim 7, wherein the first and the second lower solubility components are each sodium carbonate, and wherein the second lower solubility component has a particle size that differs from a particle size of the first lower solubility component.

15. The absorbent food pad of claim 7, wherein at least one of the first and second lower solubility components is mixed with another base.

16. The absorbent food pad of claim 15, wherein the other of the at least one of the first and second lower solubility component is mixed with calcium carbonate.

17. The absorbent food pad of claim 1, wherein the membrane is a laminate.

18. The absorbent food pad of claim 17, wherein the laminate is made of a superabsorbent material.

19. The absorbent food pad of claim 1, wherein the membrane defines a permeation barrier positioned between the acid and the low solubility component.

20. The absorbent food pad of claim 7, wherein the first pocket is formed of discrete tissue layers that are located between the top layer and the membrane, and wherein the second pocket is formed of discrete tissue layers that are located between the bottom layer and the membrane.
